(19) United States
(12) Patent Application Publication
(10) Pub. No.: US 2013/0141009 A1
(43) Pub. Date: Jun. 6, 2013

(54) LIGHTING DEVICE AND METHOD FOR CONTROLLING LIGHTING WITH REMOTE LIGHTING CONTROLLER

(71) Applicants: Wonho JIN, Seoul (KR); Hugo Jamson, Seoul (KR)

(72) Inventors: Wonho JIN, Seoul (KR); Hugo Jamson, Seoul (KR)

(21) Appl. No.: 13/419,891

(22) Filed: Mar. 14, 2012

(30) Foreign Application Priority Data
Dec. 1, 2011 (KR) 10-2011-0127792

(51) Int. Cl. H05B 37/02

(52) U.S. Cl. 315/292

(57) ABSTRACT

The specification discloses a lighting device and a method for controlling lighting with a lighting controller, wherein an example of the lighting device includes at least one light emitting device, and a lighting controller for controlling the light emitting device by predetermined communication protocol, wherein the lighting controller includes a touch unit provided to a front portion thereof having n points×m points gradations applied thereto for controlling at least one level of a color temperature level and a dimming level of the light emitting device based on information on at least one point generated according to user's touch, and the lighting controller further includes a control unit for generating and transmitting a control signal for controlling at least one level of the color temperature level and the dimming level according to information on at least one point from the touch unit.

### CROSS REFERENCE TO RELATED APPLICATION

This application claims the benefit of the Patent Korean Application No. 10-2011-0127792, filed on Dec. 1, 2011, which is hereby incorporated by reference as if fully set forth herein.

### BACKGROUND OF THE DISCLOSURE

1. Field of the Disclosure

The present invention relates to lighting devices, and more particularly to a lighting device and a method for controlling lighting with a remote controller.

2. Discussion of the Related Art

The lighting industry with a long history has researches on lighting sources, lighting systems, and driving systems for lighting still under progress.

Related art lighting systems, mostly using incandescent lamps, discharge lamps, and fluorescent lamps as light sources, have been used in various fields, such as domestic, scenery, and industry. However, among the light sources in the related art lighting systems, a resistive light source, such as the incandescent lamp, has problems of poor efficiency and heat generation, the discharge lamp has a problem come from a high price and a high voltage, and the fluorescent lamp has an environmental problem come from use of mercury.

Recently, in order to solve the problems of the light source in the related art lighting system, interest in, and researches on a light emitting diode (LED) which has advantages in efficiency, color variety, and design autonomy, are increasing as the light source in the lighting system. The LED, a semiconductor device that emits a light upon application of a voltage thereto in a forward direction, has electric, optical, and physical characteristics of a long lifetime, low power consumption, and suitable for mass production. Owing to the characteristics, the LED replaces the related art light source, rapidly.

In the meantime, large buildings and homes control the lighting systems with program switches, still.

### SUMMARY OF THE DISCLOSURE

Accordingly, the present invention is directed to a lighting device and a method for controlling lighting with a remote controller.

An object of the present invention is to provide a lighting device and a method for controlling lighting with a remote controller, and an interface thereof.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a lighting device includes at least one light emitting device, and a lighting controller for controlling the light emitting device by predetermined communication protocol, wherein the lighting controller includes a touch unit provided to a front portion thereof having n points×m points gradations applied thereto for controlling at least one level of a color temperature level and a dimming level of the light emitting device based on information on at least one point generated according to user's touch.

In another aspect of the present invention, a method for controlling lighting with a lighting controller includes the steps of connecting the lighting controller to at least one light emitting device by predetermined communication protocol, receiving information on at least one point from a touch unit provided to a front portion of the lighting controller having n points×m points gradations applied thereto, and controlling at least one level of a color temperature level and a dimming level of the light emitting device based on information on at least one point received thus.

Thus, the lighting device and the method for controlling lighting with a remote controller have the following advantages.

First, the lighting devices connected with a network can be controlled by the remote lighting controller, simply.

Second, not only the power can be controlled with the interface to the remote lighting controller, but also the color temperature and the dimming can be controlled more precisely and step by step.

Third, user's convenience and product satisfaction can be enhanced with the lighting system including the lighting device and the remote lighting controller.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates a conceptual diagram showing an example of a lighting device in accordance with the present invention.

FIG. 2 illustrates a block diagram of an example of the lighting device in FIG. 1.

FIG. 3 illustrates a block diagram of the lighting device in FIG. 1, showing an example of a detailed block diagram of a controller thereof in detail.

FIG. 4 illustrates a conceptual drawing showing an example of a lighting device including a light emitting device and a remote lighting control controller in accordance with the present invention.

FIG. 5 illustrates an example of a detailed block diagram of a remote lighting controller in accordance with the present invention.

FIGS. 6 and 7 illustrate diagrams showing examples of UIs of remote lighting controllers in accordance with the present invention, respectively.

FIG. 8 illustrates a diagram of an example of a lighting control process in accordance with the present invention.

FIGS. 9 to 11 illustrate diagrams showing an example of an actual scenario of FIG. 8 described before.

FIGS. 12 to 14 illustrate flow charts each for describing the steps of a method for controlling lighting with a remote lighting controller in accordance with the present invention.

### DESCRIPTION OF SPECIFIC EMBODIMENTS

Reference will now be made in detail to the specific embodiments of the present invention, examples of which are illustrated in the accompanying drawings.

Wherever possible, the same reference numbers will be used throughout the drawings to refer to the same or like parts, repetitive description thereof will be omitted, and for convenience sake, sizes and shapes of members shown may be exaggerated or reduced.

In the meantime, though terms including ordinal numbers, such as first or second, can be used for describing various elements, the elements are not limited by the terms, and are used only for making one element distinctive from other elements.

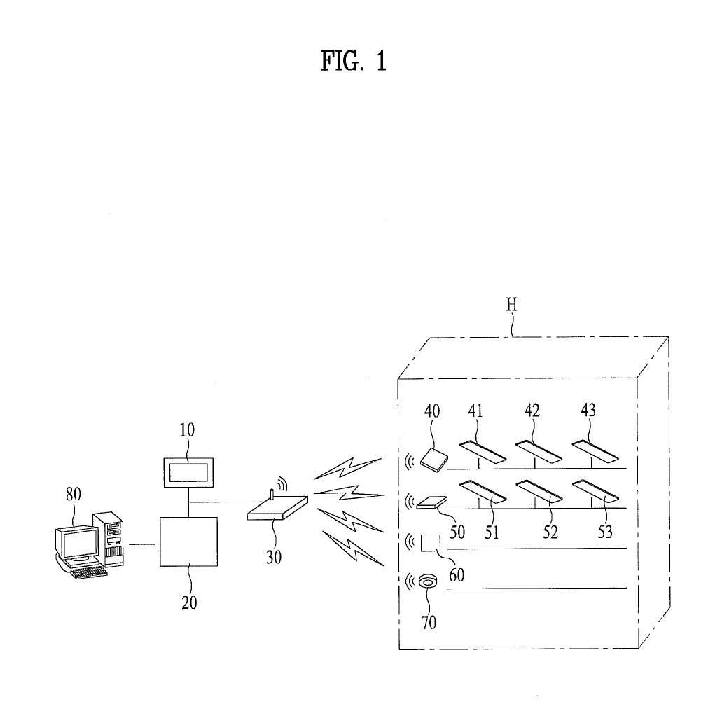

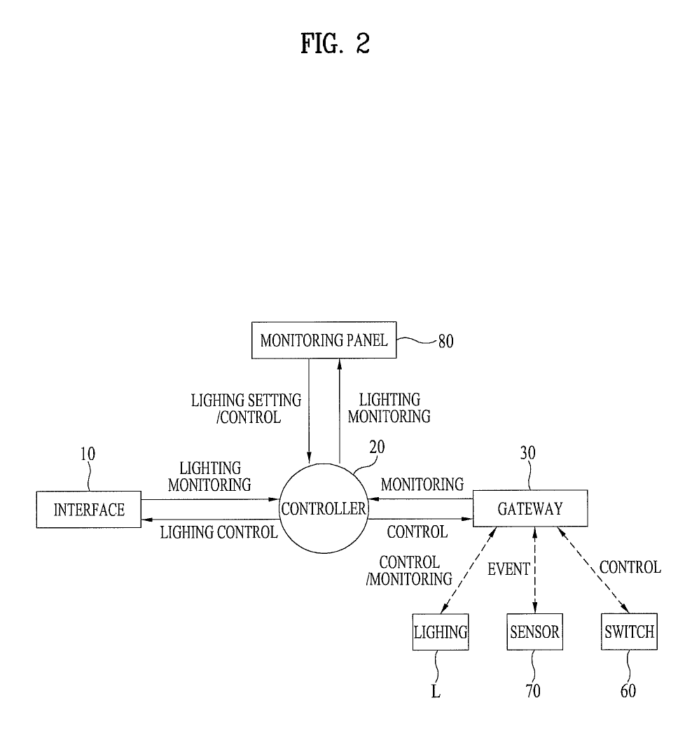

FIG. 1 illustrates a conceptual diagram showing an example of a lighting device in accordance with the present invention, and FIG. 2 illustrates a block diagram of an example of the lighting device in FIG. 1.

Elements and functions thereof of a lighting device in accordance with the present invention will be described with reference to FIGS. 1 and 2, in more detail. In this instance, the lighting device includes, for an example, lighting control means for controlling turning on/off, a color temperature, and dimming of at least one light emitting device in the lighting device. And, the lighting control means includes a remote lighting controller for controlling the light emitting device by using, for an example, by wired/wireless communication protocol. In the meantime, the wired/wireless communication protocol may include TCP/IP (Transfer Control Protocol/Internet Protocol), RS-232, RS-485, ZigBee, and the like. However, in the specification, for better understanding of the present invention and for convenience of description, though a remote lighting controller having ZigBee communication protocol applied thereto will be described as an example, scope of rights of the present invention will not be limited by this.

Referring to FIG. 1, the lighting device includes a management part, a control part, and a device part, at large.

The management part includes a monitoring panel 80, and may further include a web server. In this instance, the monitoring panel 80 may be management software or hardware operative by the management software. The web server may be connected to a user's personal computer through the Internet, for receiving and transmitting control input on the lighting device.

The management part may be connected to a controller 20 in the control part by TCP/IP or SOAP/XML (Simple Object Access Protocol/Extensible Markup Language) system, for setting, controlling, monitoring, and data exchange of the lighting device.

The control part includes a controller 20 and a gateway 30, and may further include an interface unit 10.

The controller 20 may be connected to the interface unit 10 and the gateway 30 by TCP/IP, and can control the device part through the gateway 30.

The interface unit 10 may provide a control touch panel.

Though the device part includes a device embodied in a hybrid solution type, the device part may also include a device embodied in a legacy solution type (Not shown). The hybrid solution means a solution in which devices of different purposes are combined to form a set.

One example of the hybrid solution shown in FIGS. 1 and 2 may be a combination of bridge devices BD 40 and 50 connected to the gateway 30, a plurality of light emitting units 41 to 43 and 51 to 53 connected to the bridge devices BD 40 and 50, a program switch 60, and at least one sensor 70 to form one set. In this instance, the hybrid solution may include a plurality of gateways 30, or a case in which a plurality of bridge devices BD 40 and 50 are connected to one gateway 30.

Though not shown, the legacy solution is connected to the controller 20 by 3^{rd} party protocol and may have a combination of an NCU (Network Control Unit), an LIU (Lighting Interface Unit), a CPU (Central Processing Unit), a TU (Transmission Unit), a relay, and a program switch.

And, the lighting device of the present invention may be provided to large size buildings B, and medium to small sized buildings, such as homes H. However, for better understanding of the present invention and convenience of description, though the specification describes the present invention taking the latter case, i.e., the medium to small sized buildings, such as the homes, scope of patent rights of the present invention will not be limited to this.

The medium to small sized buildings, such as the homes H, may require at least one bridge device BD 40 and 50, and a plurality of light emitting units 41 to 43 and 51 to 53 connected to each of the bridge devices and provided to enable communication.

The bridge device BD may have the switch 60 for controlling turning on/off, and an extent of dimming of the light emitting units 41 to 43 and 51 to 53, and the sensor 70 for sensing light intensity of a lighting space connected thereto further for communication to one another.

And, the monitoring panel 80 and the controller 20 may make real time management of state information on turning on/off and the light intensity of the light emitting units 41 to 43 and 51 to 53 and power consumption to find out unnecessary energy consumption units for minimizing waste of energy, building facility management, facility operation and maintenance management, maintenance of interior management of the building, and management of energy and material consumed by above managements.

In the meantime, referring to FIG. 2, a lighting L denotes the plurality of light emitting units 41 to 43 and 51 to 53 described before.

And, the light emitting units 41 to 43 and 51 to 53 include the light emitting diodes LED which may be at least one of types selected from a flat type, a bulb type and PAR type. And, the light emitting units 41 to 43 and 51 to 53 supply power to the light emitting diodes, and each of the light emitting diodes may further include a communication module (For an example, a ZigBee communication module) including means for connecting/disconnecting respective light emitting diodes.

The monitoring panel 80 stores user's setting, i.e., setting information, on the lighting L connected to the controller 20 actually, at a database, and transmits the setting information to the controller 20.

The monitoring panel 80 may communicate with the controller by SOAP which is a type of protocol for exchanging XML based messages on a network by using HTTP (HyperText Transfer Protocol), HTTPS (Hypertext Transfer Protocol over Secure Socket Layer), or SMTP (Simple Mail Transfer Protocol), or HACnet (Home Automation and Control network) which are generally known widely.

And, the monitoring panel 80 may request the controller 20 to retrieve the lighting L setting information stored thus, may transmit schedule information to the controller 20, may request the controller 20 to make group or individual control of the lighting devices, and may monitor the lighting L. In this instance, the monitoring panel 80 may control to receive information collected at the sensor 70 and to perform above control operation.

The interface unit 10 may include a display panel for applying a control order on the lighting L thereto or displaying state information on the lighting L.

The interface unit 10 may communicate with the controller 20, may transmit a control order to the controller 20 for making group or individual control of the lighting the user requests through the GUI (Graphic User Interface), and may receive and display a result of performance (Response) from the controller 20. The group may be a plurality of the lighting, as well as lighting of a storey unit or a predetermined zone unit.

The controller 20 may perform communication with an external device, and may perform control and monitoring of the lighting. The external device may be at least one of, for an example, the monitoring panel 80, the interface unit 10, and the gateway 30.

The gateway 30 communicates with the controller to receive and perform the group or individual control of the lighting, and transmits a result of the performance to the controller 20. The gateway 30 may be, for an example, a ZigBee gateway.

The bridge devices BD 40 and 50 are connected to the gateway 30 and the plurality of light emitting units 41 to 43 and 51 to 53 to enable communication for transmitting the control order from the gateway 30 to the light emitting units. And, the bridge devices BD 40 and 50 may transmit information on responses or event information on the light emitting units to the gateway 30.

Each of the bridge devices BD may be connected to the plurality of light emitting units 41 to 43 and 51 to 53 up to maximum 12 light emitting units to enable communication.

In above description, the bridge devices BD 40 and 50 and the gateway 30 may be connected by ZigBee. And, each of the bridge devices BD 40 and 50 and relevant lighting emitting units may be connected by RS-485 which is a serial connection. That is, a connection type of the bridge devices BD 40 and 50 and the gateway 30 and a connection type of each of the bridge devices BD 40 and 50 and relevant lighting emitting units may be different from each other. Or, the connection type of the bridge devices BD 40 and 50 and the gateway 30 and the connection type of each of the bridge devices BD 40 and 50 and relevant lighting emitting units may be identical to each other. That is, each of the bridge devices BD 40 and 50 and relevant lighting units may be connected by ZigBee.

The bridge devices BD 40 and 50 may generate address data and transmit the same to the lighting emitting units in a form of packets, or re-transmit a received control data to the lighting emitting units. If necessary, the bridge devices BD 40 and 50 may change the control data to a predetermined format for re-transmission of the control data to the lighting emitting units, and generate a packet including the control data changed thus. And, the address data may be generated, not by the bridge devices BD 40 and 50, but by the controller 20 or the like, and transmitted to the light emitting units through the bridge devices BD 40 and 50.

A process for transmitting the control order between the interface unit 10 and the light emitting units 41 to 43 and 51 to 53 will be described, briefly.

At first, the control order received through the interface unit 10 may be transmitted through the bridge device BD (For an example 40) which is connected to the controller 20, the gateway 30, and a relevant light emitting unit (For an example, 41) to enable communication in succession.

And, the responses or the event information on the light emitting units 41 to 43 and 51 to 53 may be transmitted to the bridge device BD (For an example 40), the gateway 30, the controller 20, and the interface unit 10 which are connected to the relevant light emitting unit (For an example, 41) in succession.

The elements in FIGS. 1 and 2 are shown for better understanding of technical aspects of the present invention and convenience of description of the present invention by the applicant. However, all of the elements shown are not essential, and may be excluded or added as necessary in embodiment of the lighting device.

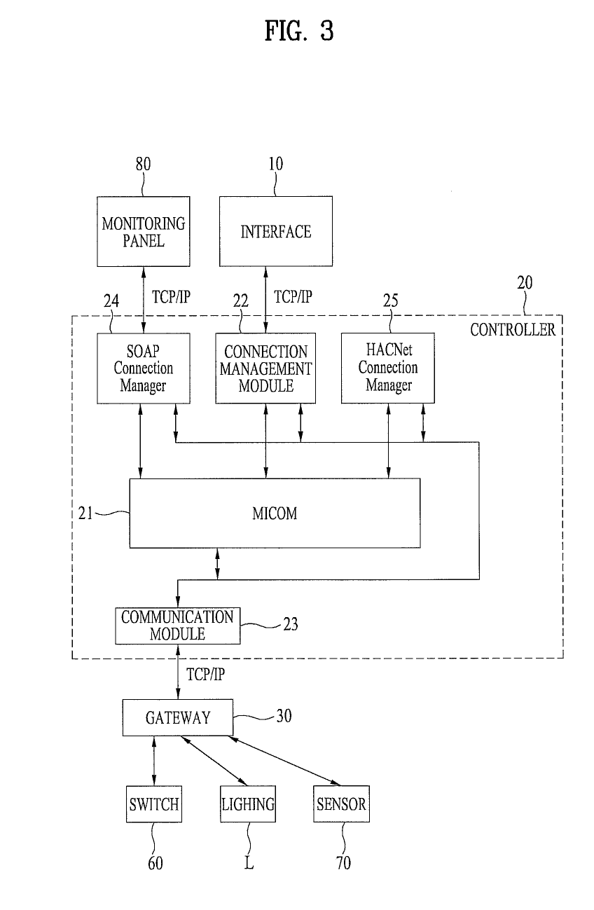

FIG. 3 illustrates a block diagram of the lighting device in FIG. 1, showing an example of a detailed block diagram of a controller thereof in detail.

Referring to FIG. 3, the controller 20 may include a MiCom (Micro-Computer) 21, a connection management module 22, a communication module 23, a SOAP connection manager 24, and a HACnet connection manager 25.

The MiCom 21, in charge of processing the lighting control, may transmit lighting control request from the interface unit 10 or the monitoring panel 80 to the communication module 23 through the SOAP connection manager 24, or the HACnet connection manager 25, to make the lighting control requested thus done. And, the MiCom 21 may transmit the response or the event information on the lighting control requested thus to the interface unit 10 or the monitoring panel 80 through the connection management module 22.

The MiCom 21 may perform the group control, the individual control, pattern control, schedule control, service interruption/power recovery control, and illumination sensor interlocked control of the light emitting units 41 to 43 and 51 to 53 or the lighting L, the switch 60, or the sensor 70.

The communication module 23 is in charge of communication between the controller 20 and the gateway 30. The communication module 23 re-constructs (Convert) the control request from the MiCom 21 into a packet which can be perceived by the light emitting units 41 to 43 and 51 to 53 or the lighting L, the switch 60, or the sensor 70, and transmits the same to the gateway 30. The communication module 23 and the gateway 30 may transmit/receive information by, for an example, TCP/IP. And, the communication module 23 receives the response information on the transmission and the event information from the gateway 30, and transmits the same to the MiCom 21.

Upon reception of the control request from the interface unit 10, the connection management module 22, the SOAP connection manager 24, and the HACnet connection manager 25 convert the control request into an internal language which can be perceived by an inside of the controller 20, and transmit the same to the MiCom 21. That is, it is required that the connection management module 22, and the managers 24 and 25 can interpret or/and convert protocol to deal with the monitoring panel 80 or the interface unit 10 connected thereto.

A method for controlling a lighting device with a remote controller in accordance with a present invention will be described, with reference to the attached drawings.

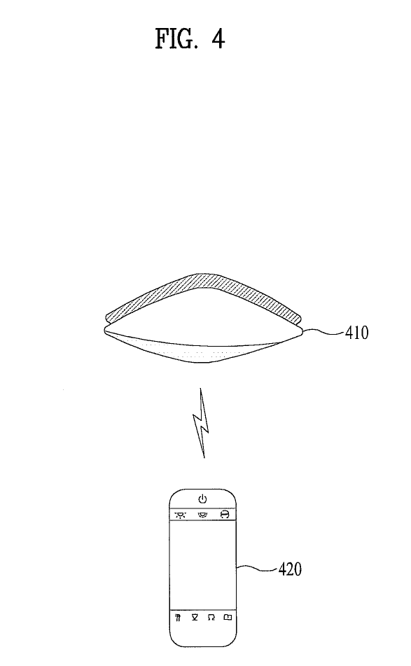

FIG. 4 illustrates a conceptual drawing showing an example of a lighting device including a light emitting device and a remote lighting control controller in accordance with the present invention.

Referring to FIG. 4, power turn on/off, a color temperature, and dimming of the light emitting device 410 may be controlled with a remote lighting controller 420 by a predetermined communication protocol.

In this instance, the light emitting device 410 may be, for an example, one of residential lighting devices, such as a domestic room lamp, or a dining table lamp.

And, the remote lighting controller 420 may make, not only control turning on/off of a main lamp and/or a supplementary lamp, but also smart control or precise control of the color temperature level and the dimming level according to an environmental brightness.

Along with this, as described before, as the predetermined communication protocol, the ZigBee communication protocol at 2.4 GHz may be suggested.

In the meantime, the remote lighting controller 420 may control a plurality of the lighting emitting devices at a time.

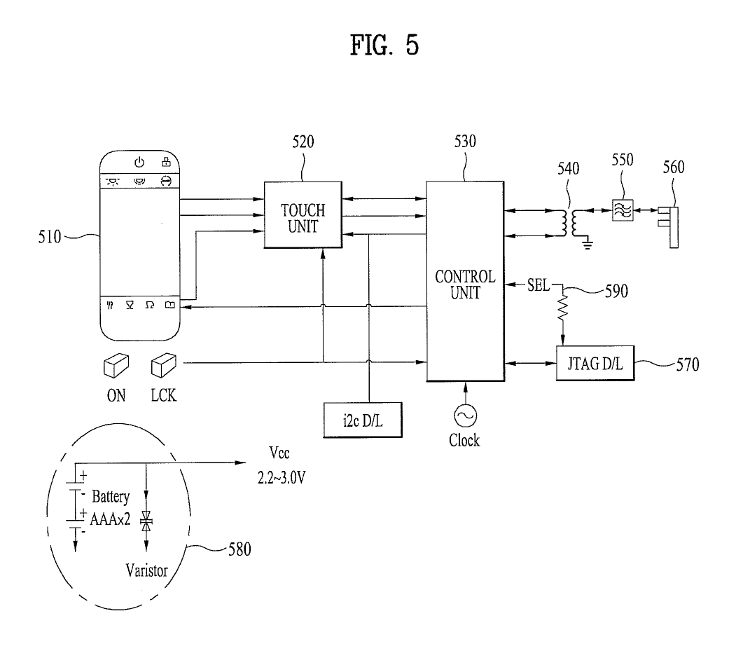

The remote lighting controller will be described in more detail. FIG. 5 illustrates an example of a detailed block diagram of a remote lighting controller in accordance with the present invention.

Referring to FIG. 5, the remote lighting controller 510 includes, for an example, a touch unit 520, a control unit 530, a transformer 540, a filter 550, an antenna 560, and a power supply 580.

The touch unit 520 has m points×n points gradations applied thereto for generating point information on a portion the user touched and transmission of the same to the control unit 530. In generation of the touch point information, the touch unit 520 may refer to coordinate information based on rectangular coordinates, and, even in a case of drag after final touch, or in a case of a continuous touch, the touch unit 520 may generate the touch point information on each of the cases and transmit the same to the control unit 530. In above description, in the case of drag, the touch unit 520 may only generate and transmit, for an example, information on an initial touch point and information on a touch point the drag ends as the touch point information. In the meantime, in a case information on a plurality of touch points exists including the case of drag, the touch unit 520 may transmit information on a direction based on the rectangular coordinates. The information on direction may be information for identifying up/down directions, left/right directions, and diagonal directions. Along with this, if only a piece of point information exists, though it may be adequate that the touch unit 520 transmits the coordinate information, if a plurality of pieces of point information are generated, the touch unit 520 may transmit information on point differences among information on each of the points together with the coordinate information. And, particularly, if the direction information is the diagonal direction, the touch unit 520 may transmit information on the point differences in the up/down direction and in the left/right direction based on the rectangular coordinates.

The control unit 530 may be a 2.4 GHz ZigBee wireless communication transceiver system on chip SoC with an IEEE 802.15.4 MAC/PHY built therein.

The control unit 530 may also have a processor, a FLASH/SRAM, and an encoding means built therein. Besides those, the control unit 530 may use SPI (Ethernet, EEPROM), TWI (RTC module), and JTAG (SIF) interface.

The transformer 540 may be a Balun (Balance to unbalance transformer) having a larger conversion if a high impedance balancing antenna is matched with a low impedance unbalancing receiver, transmitter, or a transceiver. The transformer 540 may have, for an example, a 100 Ω difference signal for converting the 100 Ω impedance into 50 Ω impedance at the antenna according to a transmission/reception signal for filtering to pass a 2.4 GHz band only.

The filter 550 is, for an example, an LPF (Low Pass Filter) for removing harmonic components from an output as well as filtering a high frequency component.

The antenna 560 transmits an RF (Radio Frequency) signal coupling to the air, and receives an incoming RF signal.

The power supply 580 receives and converts a 5V DC into a constant 3.3V DC, and supplies the same to a ZigBee chip component and the like.

Besides above elements, the remote lighting controller 510 performs functions such as testing on connection states among devices or fusing at a memory, and may further include JTAG (Joint Test Action Group) connector 570 which performs functions of downloading ZigBee software program and debugging.

And, the remote lighting controller 510 may further include a memory, a driver, a buffer unit, an I/O port, and an I/F connector.

The memory may be an EEPROM (Electrically Erasable Programmable Read-Only Memory) which is a kind of non-volatile memory, with a size of, for an example, 128 Kbyte. And, the memory may be used as a temporary DataROM if updating a ZigBee Firmware, wirelessly. In the meantime, as described later, the memory may have a reference table having preset values on, for an example, color temperature levels and dimming levels stored therein to be used as reference for the control unit 530 to determine a control level according to an input from the touch unit 520.

The driver is used for long range communication with a differential line from an external device by a half duplex type in UART communication.

The buffer unit, being a PWM (Pulse Width Modulation) type, may adjust brightness of an external device (For an example, a dimming connector) by variation of a pulse width of a 500 Hz pulse.

The I/O port is connected to 12 light emitting units with a half duplex type RS 485 communication for individual control of the 12 light emitting units and drives internal circuits with a +5V DC supplied thereto from an external device. The I/F connector has 5V DC power supplied thereto through an external device (For an example, a dimming connector connected thereto), for providing a 5V PWM signal to make a pulse width modulation control for dimming a down light.

In above, the control unit 530 may generate a control signal such that the control unit 530 selects a room lamp if the control unit 530 receives a high value through a selection unit 590, and a dining table lamp if the control unit 530 receives a low value through the selection unit 590. Similarly, the control unit 530 may determine an input from the selection unit 590 as an input for performing a control function, such as activation of a direct lamp, an indirect lamp, and a smart function, to be described later, and generate a control signal for performing a control function.

In the meantime, the control unit 530 may determine an input upon reception of the input from the user, and receive a clock signal including an interrupt signal for generating the control signal in compliance with the input.

And, though not shown, the remote lighting controller 510 may have a communication module provided therein for making the ZigBee communication described before. And, in conformity with the communication type of the remote lighting controller, each of the light emitting units in the lighting device may also have a communication module provided therein for making the ZigBee communication for receiving the control signal. The communication module may be used for firmware upgrade, later.

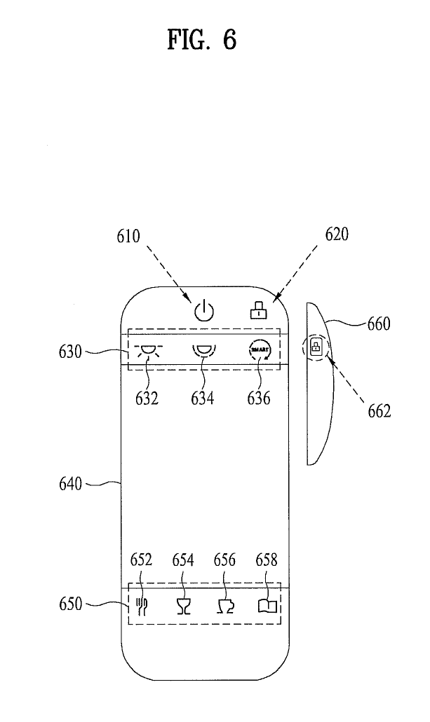

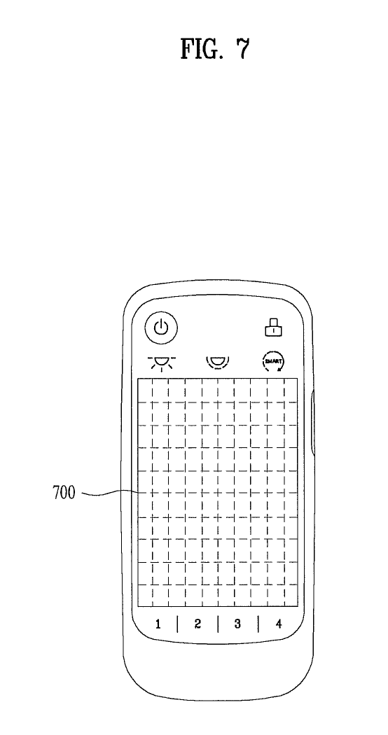

FIGS. 6 and 7 illustrate diagrams showing examples of UIs (User interfaces) of remote lighting controllers in accordance with the present invention, respectively.

Referring to FIGS. 6 and 7, the remote lighting controller 510 has a front portion and a side portion 660, and the front portion may be divided into three regions. In the meantime, the side portion 660 may include a hold button 662 for user's application to perform a general function thereof, and controlling whether the application is put into actual operation or not in a state power of the remote lighting controller 510 is turned on. In this instance, as an example, though it is shown that the side portion 660 has the hold button 662 provided to a right side of the remote lighting controller 510, the position of the hold button 662 is not limited to this, but the hold button 662 may also be provided to any one of a left side, an upper side, and a lower side. And, besides the hold button 662, the side portion 660 may further include a power button, or predetermined function buttons.

Hereinafter, the front portion of the remote lighting controller will be described in detail. As described before, hereinafter, for better understanding of the present invention and convenience of description, the front portion of the remote lighting controller will be described, dividing the front portion into a first region, a second region, and a third region. In the meantime, hereinafter, at first, the UIs of the remote lighting controller will be described with reference to FIG. 6, and the remote lighting controller will be described with reference to FIG. 7 focusing on points of differences from FIG. 6.

At first, the first region may be positioned on an upper side of the remote lighting controller, and include a power button 610 in a form of a shade for power turning on/off, a hold indicating icon 620 for indicating whether the remote lighting controller is locked or not according to selection of the hold button 662 at the side portion described before, and first function icons 630.

In this instance, the power button 610 may be embodied in, for an example, a tact switch, together with the hold button 662 at the side portion described before. And, the power button 610 and the hold indicating icon 620 may turn on/off backlight LEDS provided on insides of relevant buttons and icons so that the user perceives whether power of the remote lighting controller 510 is turn on or not, and whether the hold function is activated or not, immediately respectively. And, if the hold button 662 is not provided to the side portion 660, the hold button 662 may be embodied at the first region in a tact switch like the power button 610. Along with this, the hold button 662 at the side portion has a side knob applied to a position which is variable.

The first function icons 630 may include, according to types of the light emitting units, at least one of a direct lamp selection function icon 632, an indirect lamp selection function icon 634, and a smart function icon 636 for controlling smart operation of at least one of the direct lamp and the indirect lamp. In other words, when the user selects at least one of a direct lamp, an indirect lamp, and a smart function with the remote lighting controller, the first function icons 630 indicate whether a selected function is activated or not. In the meantime, the first function icons 630 not only indicate whether a function is activated or not in a form of an icon, but also the first function icons 630 may be embodied in a formed of a tact switch like the touch key, the power button 610 or the hold button 662 described before to enable to make direct selection of a function like a button. And, each of the first function icons may employ individual backlight LED, and may use a yellow-green LED as the backlight LED. Accordingly, as described before, depending on whether a function is put into operation or not, each of the first function icons 630 can indicate whether the relevant function is activated or not.

The first function icons 632 to 636, for a kind of group control, are provided for convenience of the user in a case identical control is not possible due to characteristics of the light emitting units. In the meantime, the smart function can be implemented or controlled even if any one of the direct lamp and the indirect lamp is not selected.

While the first function icons 632 to 636 are provided for selection of the light emitting device or the smart function, the second function icons 652 to 658 at the third region 650 is provided for various mode control functions. As shown in FIG. 6, the modes may be, for an example, a dining mode 652, a wine mode 654, a tea time mode 656, a reading mode 658 and so on. As shown in FIG. 6, the user may have better convenience by providing individual icons for the modes, or, as shown in FIG. 7, even though no individual icons are provided, the modes may be used by making storage of modes requested by the user possible at user's option. In this case, besides the modes in FIG. 6, various modes may be provided, to store first to nth modes (Where, n is a positive integer) in a memory at user's option, to perform the functions, and to indicate whether the functions are activated or not. In the meantime, a light emitting mode of the icon selected from the third region may be operated in a contextual mode including a plurality of mode icons preset taking at least one of time, weather, a user's intention, and an environment into account.

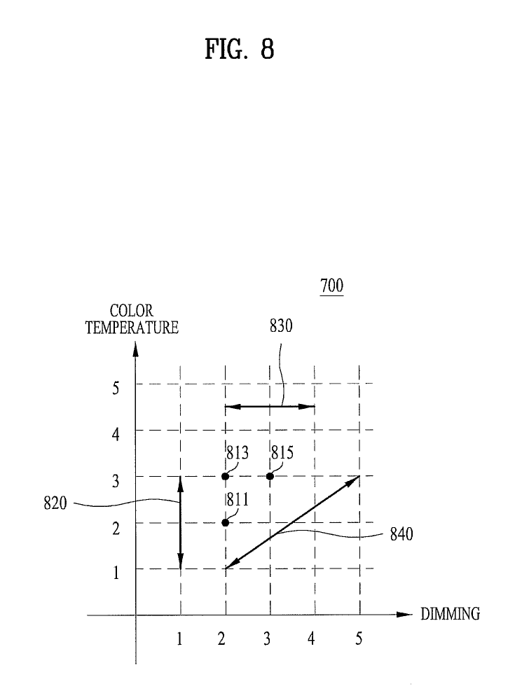

The second region 640 has a touch screen provided thereto having, as shown in FIGS. 7 and 8, n points×m points gradations applied thereto. The touch screen at the second region 640 may, for an example, perceive a user's input with the gradations, enabling to control the color temperature, the dimming and so on in more detail or in more precisely, for an example, 256 gradations. The control on the color temperature, the dimming and so on will be described with reference to FIG. 8 described later 9 in detail, while the detailed description thereof is omitted herefrom.

In the meantime, the touch screen at the second region may, not only receive the input for the control described before, but also display various data or output together with audio in association with, or independent from, the first region and the second region described before. For an example, if the remote lighting controller is turned on, the touch screen at the second region may indicate power turn on, remained battery charge of the remote lighting controller, memory states (A whole size, an available size, and so on), whether the hold button is activated or not, whether a function is activated or not, and the light emitting devices selected together with map information at the time of selection of the first function icons. In other words, the touch screen at the second region may perform a window function for providing various function indications of the remote lighting controller and related data together with as means for inputting point information for the lighting control. Thus, the first function icons 630 and the second function icons 659 are described. However, the first function icons 630 and the second function icons 659 described thus are, not limited by what is shown in the drawings positively, but may be embodied at various positions and in various forms within a predetermined region in the remote lighting controller for convenience of the user. For an example, positions of the first function icons 630 and the second function icons 659 may be interchanged, the second function icons 650 may be positioned under the first function icons 630, or the first function icons 630 may be positioned under or over the second function icons 650. Or, at least one of the first function icons 630 and the second function icons 650 may be embodied, not in left/right or width direction, but p/down or length direction on a front view. Besides, a region having at least one of the first function icons 630 and the second function icons 650 are arranged thereon is provided, not in a form of fixed icons, but in a form of a touch screen, for providing the icons at user's option. In this case, at least one of the first function icons 630 and the second function icons 650 is contained in the touch screen at the second region so as to be displayed at a predetermined region of the touch screen only when the user requests. In the meantime, an entire remote lighting controller may become a touch screen, when the function icons described before may be displayed always or upon request at a predetermined region of the touch screen.

Basically, the remote lighting controller of the present invention may be shifted to a sleep mode for saving power consumption if a preset time period is passed after a last key or input. The preset time period may be, for an example, 10 seconds. The sleep mode may be embodied such that brightness of LEDS for some of the buttons and icons, such as a power button, is adjusted to predetermined power or enough to make a Picto visible. When the user presses a particular button or region, such as the power button, the hold button, and the touch region of the remote lighting controller in the sleep mode, the sleep mode is shifted to a wake up mode. In this instance, the wake up mode is an opposite concept of the sleep mode, in which a function is put into operation upon selection of a button or an icon, right away. In above, it may also made possible that the remote lighting controller may be shifted from the sleep mode to the wake up mode right away upon touching anywhere of the front portion or the side portion of the remote lighting controller even if it is not the particular button or the icon.

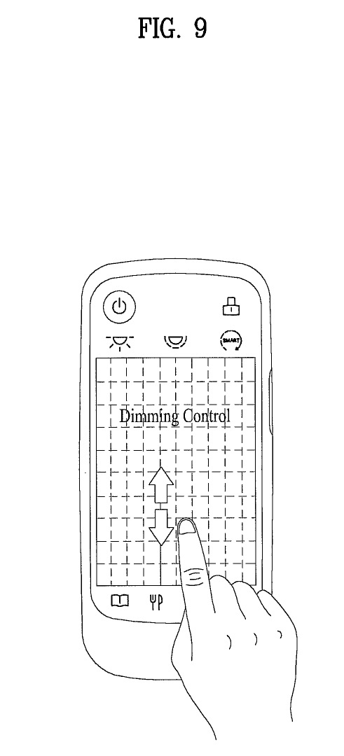

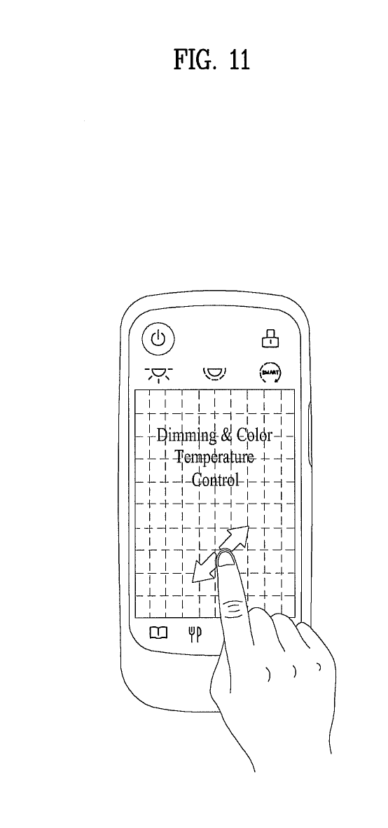

As described before, the touch screen in FIGS. 6 to 7 may become means for controlling the color temperature or the dimming of the light emitting device. FIG. 8 illustrates a diagram of an example of a lighting control process in accordance with the present invention, and FIGS. 9 to 11 illustrate diagrams showing an example of an actual scenario of FIG. 8 described before.

For convenience of description of a method for controlling a lighting device of the present invention, description with reference to FIG. 8 will be made with reference to the touch screen illustrated in FIGS. 6 to 7 by using rectangular coordinates. The rectangular coordinates are matched, for an example, with the n points×m points gradations.

Though FIG. 8 shows a color temperature level on a longitudinal axis Y and a dimming level on a transverse axis X for convenience's sake, the representation is not limited to this. That is, the representation may be embodied opposite to above. And, numerals on the longitudinal axis and the transverse axis may be control levels assigned in advance. The control level may be stored, for an example, in a memory in the remote lighting controller in a form of a table in advance to determine an extent of control per each level in advance.

Referring to FIG. 8, the color temperature level and the dimming level may be controlled, individually or at a time. Of course, besides the color temperature and the dimming, it is apparent that other functions may also be controlled by the same method at user's option.

For an example, if the user intends to control only one of the color temperature and the dimming with the remote lighting controller, the user may activate a function and touches a desired point. In this case, as shown in FIG. 7, by providing a grating shape, user's convenience may be provided. For an example, FIG. 8 shows three points, i.e., a first point 811, a second point 813, and a third point 815. In this instance, the first point 811 makes the color temperature or dimming level to be controlled in level two depending on a requested function. Of course, if all of the two functions are requested, both the color temperature and dimming levels are controlled to be level two. In this case, the control unit 530 of the remote lighting controller receives information on a point the user touched, compares the information to a function requested in advance to determine a control level matched to the point information, and generates and transmits a control signal such that a function level of the light emitting device is controlled at the requested level. The second point 813 may induce point information on level two dimming, and a level three color temperature, and the third point may induce point information on level three dimming and a level three color temperature. The point information induced thus is transmitted to the control unit 530 through the touch unit 520 and used for generating a control level. In this case, the remote lighting controller of the present invention may use colors so that the user can make easier control according to an extent of a lighting control level by dividing the remote lighting controller into left/right, and up/down. For an example, by providing a blue color to a left side of the touch screen and a red color to a right side of the touch screen, and varying saturation of the colors or the like in up/down or left/right directions to move up the level the higher as the saturation is the higher, and to move down the level as the saturation is the lower, thereby providing user's convenience. And, even in a case only one color is used, as shown in FIG. 8, by making saturation of the color the higher as the color goes from a left lower side of the touch screen to a right upper side of the touch screen the more, user's convenience may be provided. However, the present invention is not limited to this, but methods which may provide user's better perception or/and convenience of selection in various ways may be employed.

Above description is on a case the user touches at least one point. In the meantime, the user does not touch a point on the touch screen, but the user may also drag after the user touches the point.

In the drag, there may be, for an example, a first drag 820 in the up/down directions, a second drag 830 in the left/right directions, and a third drag 840 in the diagonal directions. In this instance, the first drag 820 and the second drag 840 may not require selection of the control function in advance. For an example, since the first drag 820 is made only in the up/down directions, only the control level of the color temperature may be fixed, while the control level of the dimming is not fixed. And, since the second drag 830 is made in the left/right directions, only the control level of the dimming may be fixed, while the control level of the color temperature is not fixed.

In the case of the first drag 820, the touch unit 520 may collect information on a plurality of point of a first point to an (n)th point. In this instance, the touch unit 520 may extract information on the first point which is an initially touched portion and information on the second point which is a finally touched portion, and may transmit the information to the control unit. The control unit 530 calculates a difference of levels of the second point information and the first point information received from the touch unit 520, determines a control level according to the information, generates a control signal in conformity with the control level determined thus, and transmits the control signal to the light emitting device. In this instance, the control signal may be generated based on, for an example, present level information received from the light emitting device. That is, if the control level determined thus is two levels, the control unit 530 may generate the control signal such that the light emitting device adjusts two levels from the present level, or the control unit 530 may receive the present level information from the light emitting device, calculate a level which has a two level difference from the present level of the light emitting device, generate a control signal including a level obtained by the calculation, and transmit the control signal to the light emitting device.

The case of the second drag 830 is identical to the case of the first drag 820. However, directions are not the up/down directions, but the left/right directions.

And, with regard the first touch point and the second touch point, the control unit 530 may, for an example, the first point and the second point may add to or subtract from the other, to move up the level if a positive value is obtained, or move down the level if a negative value is obtained. The positive value may be obtained in a case, for an example, the first touch point has a level lower than the second touch point, and the negative value may be obtained in a case the first touch point has a level higher than the second touch point.

The first drag 820 and the second drag 830 can only make the color temperature control and the dimming control, respectively. In the meantime, the third drag 840 is made in the diagonal directions when, identical to above methods, both the color temperature control and the dimming control may be made at a time by using a plurality of touch point information from the touch unit 520.

For an example, alike the first drag 820 and the second drag 830, the touch unit 520 may collect information on the first point which is an initially touched point and information on the second point which is a finally touched point, and may transmit the information to the control unit 530, or may transmit information on a third point where the transverse axis and the longitudinal axis of the rectangular coordinates meet together with the information on the first point which is an initially touched point and information on the second point which is a finally touched point to the control unit 530. Referring to FIG. 8, for an example, if the color temperature and the dimming are taken as Y and X coordinates of the rectangular coordinates, (2,1) is the first point information, (5,3) is the second point information, and (5,1) is the third point information.

If the touch unit 520 transmits information on a plurality of points like the rectangular coordinates to the control unit 530, the control unit 530 may determine control levels of the color temperature and the dimming respectively by using the point information received thus, generate the control signal, and transmit the same to the light emitting device. In this case, the control signal may be generated for each of the color temperature and the dimming, or in one. For an example, in the case of the third drag, the control unit 530 may generate the control signal based on the third point information such that three levels of dimming and two levels of color temperature can be controlled at the same time.

Or, the control unit 530 may generate the control signal such that the dimming and the color temperature are controlled, not with different values, but with identical values according to the point info illation on the dimming and the color temperature. For an example, in the case of the third drag 840, while the control unit 530 may make the dimming and the color temperature themselves to have the same level always (For an example, both the dimming and the color temperature have a k level, where k is a positive integer) according to an extent of the drag obtained from the information on a plurality of points, the values are fixed in a form of a table according to the point information in advance.

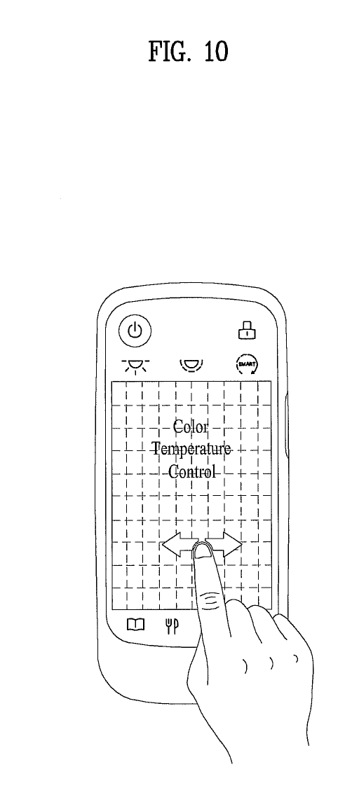

Thus, a method for controlling operation on the color temperature and the dimming of the present invention is described, with reference to FIG. 8. In the meantime, FIGS. 9 to 11 illustrate examples of actual control operation of dimming, color temperature, dimming and color temperature simultaneous control, respectively. However, in this instance, different from FIG. 8, FIGS. 9 to 10 illustrate cases of examples in which a longitudinal direction touch and drag is dimming control, and transverse direction touch and drag is color temperature control. That is, though a principle of task resolution is the same, the function of the remote lighting controller may be defined in advance, or may be changed or modified at user's option as many as the user likes. In the meantime, though the specification describes the color temperature and dimming control as an example thus, the present invention is not limited to those functions, but the remote lighting controller may be set such that different functions may be defined, applied, and controlled at user's option as many as the user likes.

The foregoing description is made on a case in which, in generation of the control signal at the control unit 530 according to the point information from the touch unit 520, the control signal is transmitted after entire touch is finished to control a relevant light emitting device. However, in this case, many times of touch and control processes may be required for the user to make the control at a desired exact level. In order to solve the problem, particularly, in the case of touch and drag, by transmitting information on the touch point to the control unit 530 immediately at every touch starting from an initial touch portion even if the touch is not finished, for the control unit 530 to generate and transmit the control signal enabling the user to determine a level of control made by the present level of touch immediately, it may be possible to finish the control process only one time of touch and drag. In this case, since the light emitting device may control a function according to the control signal immediately, the user may finish the level of touch and drag in one time by determining the control level as much as touched with user's eyes, directly.

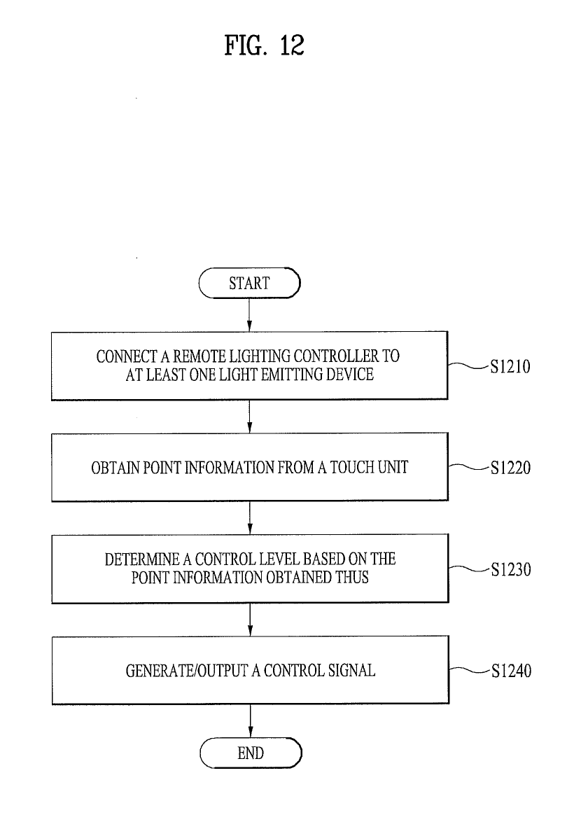

FIGS. 12 to 14 illustrate flow charts each for describing the steps of a method for controlling lighting with a remote lighting controller in accordance with the present invention.

Referring to FIG. 12, in one example of the method for controlling lighting with a remote lighting controller in accordance with the present invention, the remote lighting controller is connected to at least one of the light emitting devices (S1210). In this instance, the connection of the two devices means, for an example, an entire process for making data transmission/reception possible between the devices by a predetermined communication protocol described before, collectively. The process may also be called as an initializing step before starting the control.

When the remote lighting controller is connected to the light emitting device in the step S1210, the remote lighting controller obtains a level the user intends to control with the touch screen, i.e., point information (S1220). The step may be performed at the touch unit 520, in which, as described before, if there is information on a plurality points, the touch unit 520 may extract the first point information and the second point information or the first point information to the third point information, and may transmit the same to the control unit 530 individually, or may transmit the point information to the control unit 530 every time the point information is generated, immediately.

The control unit 530 determines the control level based on the point information obtained thus (S1230), detailed description of which may be made identical to the method described with reference to FIG. 8 before.

The control unit 530 generates the control signal according to the control level determined in the step S1230 thus, and transmits the control signal to the light emitting device to control the light emitting device (S1240).

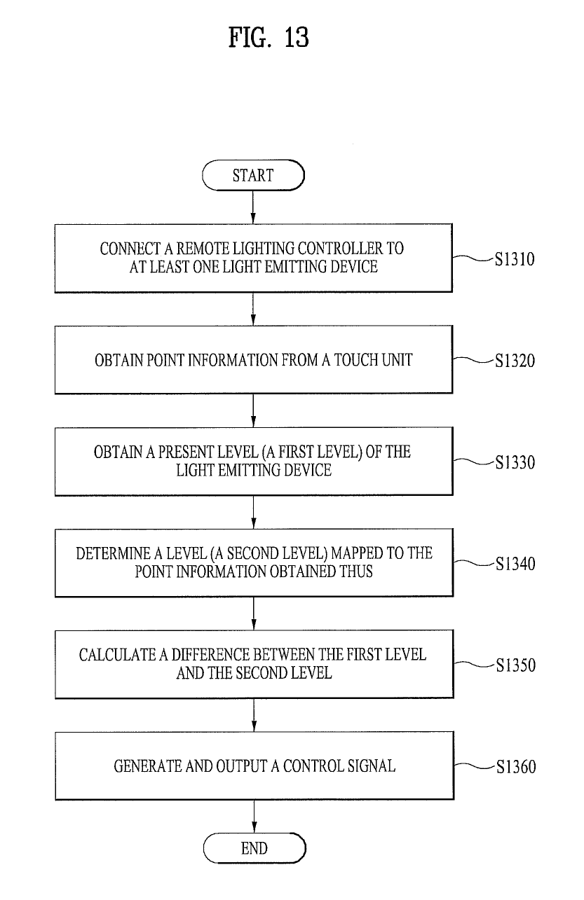

Next, another example of the method for controlling lighting with a remote lighting controller in accordance with the present invention will be described with reference to FIG. 13. In this instance, detailed description of parts which duplicate with FIG. 12 will be omitted, while applying or invoking contents of the description made before to the another example. That is, since the steps S1310 and S1320 in FIG. 13 are the same with the steps S1210 and S1220 in FIG. 12, the steps S1210 and S1220 in FIG. 12 will be invoked to another example.

The control unit 530 obtains the point information from the touch unit 520, at the same time with or before or after the obtainment, obtains the present level (A first level) information on the light emitting device (S1330), determines a level (A second level) mapped to the first level obtained thus and the point information obtained at the touch unit 520 (S1340), and calculates a difference between the first level and the second level (S1350).

Then, the control unit 530 generates and transmits a control signal for controlling the light emitting device at a level according to the difference between the first level and the second level calculated thus (S1360).

In above description, the second level may be determined based on, for an example, the first point information and the second point information or the first point information to the third point information, or with reference to a mapping table defined based on the point information, in advance.

In the meantime, with regard to above description, as described before, in order to move up or down the level as much as required, the control unit 530 may generate the control signal to include a difference of levels and transmit the control signal to the light emitting device, or the control unit 530 may calculate and determine a value of difference in advance and transmit a control signal including a level determined thus to the light emitting device for the light emitting device to change to the level, immediately. That is, the former is one in which a level difference is transmitted and the light emitting device controls as much as the difference, and the latter is one in which the control is made by specifying a level to be changed based on the level difference calculated at the control unit and the present level of the light emitting device.

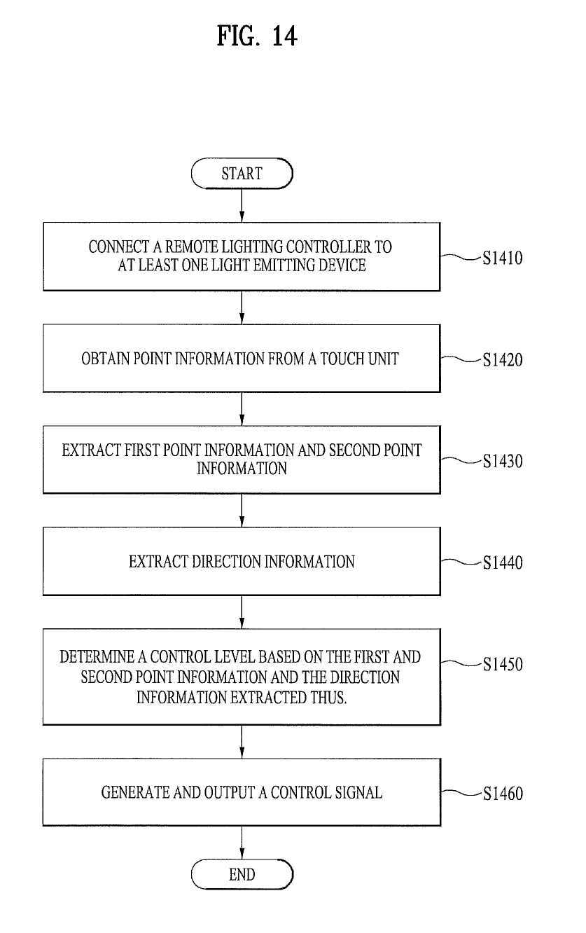

Since FIG. 14 is similar to FIG. 13 in general, FIG. 14 will be described on only parts different from FIG. 13. FIG. 14 had direction information added to FIG. 13.

Upon reception of the point information in the steps S1410 and S1420, the control unit extracts the first point information and the second information, or the first point information to the third information from the information on the plurality of points described before (S1430). Together with this, the control unit extracts direction information (S1440), and determines a function to be controlled and a control level based on the point information and the direction information (S1450), generates a control signal according to the control level determined thus, and transmits the control signal to the light emitting device to make control of the light emitting device.

As have been described, the lighting device and the method for controlling lighting with a remote lighting controller of the present invention have the following advantages.

The lighting device connected with a network can be controlled with the remote lighting controller simply, power can be controlled with an interface to the remote lighting controller, the color temperature and the dimming can also be controlled precisely and step by step, and the lighting system including the lighting device and the remote lighting controller enhances user's convenience and product satisfaction.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A lighting device comprising:
at least one light emitting device; and
a lighting controller for controlling the light emitting device by predetermined communication protocol,
wherein the lighting controller includes a touch unit provided to a front portion thereof having n points×m points gradations applied thereto for controlling at least one level of a color temperature level and a dimming level of the light emitting device based on information on at least one point generated according to user's touch.

2. The lighting device as claimed in claim 1, wherein the lighting controller is any one of a remote controller and a wired controller, and further includes a control unit for generating and transmitting a control signal for controlling at least one level of the color temperature level and the dimming level according to information on at least one point from the touch unit.

3. The lighting device as claimed in claim 2, wherein the control unit generates the control signal based on a difference between a mapping level preset on the point information from the touch unit and a present level of the light emitting device.

4. The lighting device as claimed in claim 2, wherein the control unit generates the control signal based on, of information on a plurality points from the touch unit, first point information on an initial touch point and second point information on a final touch point.

5. The lighting device as claimed in claim 4, wherein the control unit generates the control signal by mapping the first point information and the second point information to direction information based on rectangular coordinates for controlling at least one level of the color temperature level and the dimming level.

6. The lighting device as claimed in claim 5, wherein the control unit generates the control signal for controlling the dimming level if the direction information mapped according to the first point information and the second point information is a first direction, and generates the control signal for controlling the color temperature level if the direction information mapped according to the first point information and the second point information is a second direction.

7. The lighting device as claimed in claim 6, wherein the control unit generates a control signal for controlling the color temperature level and the dimming level at a time, if the direction information mapped according to the first point information and the second point information is a third direction.

8. The lighting device as claimed in claim 7, wherein the control unit generates control signals for each of the color temperature level and the dimming level respectively determined according to numbers of points of the first point information and the second point information, if the direction information mapped according to the first point information and the second point information is the third direction.

9. The lighting device as claimed in claim 8, wherein the control unit perceives the first direction as left/right directions, the second direction as up/down directions, and the third direction as diagonal directions and generates the control signal according to the perception.

10. The lighting device as claimed in claim 4, wherein the control unit determines control signals for respectively controlling the color temperature level and the dimming level according to numbers of the points, linearly.

11. A method for controlling lighting with a lighting controller comprising the steps of:
connecting the lighting controller to at least one light emitting device by predetermined communication protocol;
receiving information on at least one point from a touch unit provided to a front portion of the lighting controller having n points×m points gradations applied thereto; and
controlling at least one level of a color temperature level and a dimming level of the light emitting device based on information on at least one point received thus.

12. The method as claimed in claim 11, further comprising the step of generating a control signal for controlling at least one level of the color temperature level and the dimming level according to information on at least one point from the touch unit.

13. The method as claimed in claim 12, wherein the lighting controller is any one of a remote controller and a wired controller, and the control signal is generated based on a difference between a mapping level preset on the point information from the touch unit and a present level of the light emitting device.

14. The method as claimed in claim 12, wherein the control signal is generated based on, of information on a plurality points from the touch unit, first point information on an initial touch point and second point information on a final touch point.

15. The method as claimed in claim 14, wherein the control signal is generated by mapping the first point information and the second point information to direction information based on rectangular coordinates for controlling at least one level of the color temperature level and the dimming level.

16. The method as claimed in claim 15, wherein the control signal is generated for controlling the dimming level if the direction information mapped according to the first point information and the second point information is a first direction, and the control signal is generated for controlling the color temperature level if the direction information mapped according to the first point information and the second point information is a second direction.

17. The method as claimed in claim 16, wherein the control signal is generated for controlling the color temperature level and the dimming level at a time, if the direction information mapped according to the first point information and the second point information is a third direction.

18. The method as claimed in claim 17, wherein the control signals are generated for each of the color temperature level and the dimming level respectively determined according to numbers of points of the first point information and the second point information, if the direction information mapped according to the first point information and the second point information is the third direction.

19. The method as claimed in claim 18, wherein the control signal is generated according to perception that the first direction is left/right directions, the second direction is up/down directions, and the third direction is diagonal directions.

20. The method as claimed in claim 14, wherein the control signal is determined for controlling the color temperature and dimming level according to a number of the points, linearly.
